(19) United States
(12) Patent Application Publication
(10) Pub. No.: US 2020/0056030 A1
(43) Pub. Date: Feb. 20, 2020

(54) SEALING ELEMENT AND/OR GUIDE RING MADE OF A COMPOSITION OF POLYTETRAFLUOROETHYLENE, PERFLUOROALKOXY POLYMER, AND FILLER

(71) Applicant: BURCKHARDT COMPRESSION AG, Winterthur (CH)

(72) Inventor: Bernhard Dominik THURNHERR, Bulach (CH)

(73) Assignee: BURCKHARDT COMPRESSION AG, Winterthur (CH)

(21) Appl. No.: 16/342,815

(22) PCT Filed: Oct. 9, 2017
(86) PCT No.: PCT/EP2017/075615

§ 371 Date: Apr. 17, 2019

(30) Foreign Application Priority Data
Oct. 17, 2016 (EP) 16194090.3

(51) Int. Cl. C08L 27/18; C08L 27/22; C08K 3/013; C08L 71/12; C08L 79/08; C08L 81/00; F16J 9/28; F16J 15/10

(52) U.S. Cl. CPC C08L 27/18; C08L 27/22; C08K 3/013; C08L 71/12; C08L 79/08; C08K 3/04; F16J 9/28; F16J 15/102; C08L 2205/025; C08L 2205/03; C08L 81/00

(57) ABSTRACT

The present invention relates to a sealing element and/or guide ring manufactured from a composition comprising:
i) 50% to 98% by weight of polytetrafluoroethylene and/or modified PTFE,
ii) 1% to 49% by weight of perfluoroalkoxy polymer and
iii) 1% to 49% by weight of an inorganic filler selected from the group comprising charcoal, graphite, glass fibers, carbon fibers, molybdenum disulfide, metals such as copper, alloys such as bronze, ceramic particles such as aluminum oxide and any desired mixtures of two or more of the aforementioned substances.

The present invention relates to a sealing element and/or a guide ring manufactured from a composition, and to a process for producing such a sealing element or guide ring.

Sealing elements such as piston rings or packing rings as well as guide rings such as piston guide rings as well as guiding sealing rings such as piston guide sealing rings must fulfill a multitude of requirements in order to fulfill their function. More particularly, these must have suitable hardness, sufficiently high tensile strength, sufficiently high elongation at break, good conformability, high aging resistance, low tendency to creep under pressure and to cold flow, outstanding chemical stability, excellent thermal stability and, depending on the application, possibly high ozone resistance. For example, a good form adaptability is required to ensure the function of the sealing element, even when it is moving. Moreover, a low tendency to creep under pressure and to cold flow is essential in order to avoid irreversible plastic deformation in the cold state under load even after a long operating time.

Due to its good properties, sealing elements are increasingly being produced from compositions based on polytetrafluoroethylene (PTFE). PTFE, for example, is characterized by an exceptionally broad thermal application range, is almost universally chemically stable and has excellent resistance to light, weathering and hot steam. Moreover, PTFE is notable for very good sliding properties, excellent anti-adhesive characteristics and good dielectric properties. Moreover, it is also physiologically harmless. However, PTFE is characterized by comparatively low mechanical stability and especially also by poor cold flow properties, namely high cold flow.

Due to its comparatively low mechanical stability, sealing rings are not produced from pure PTFE but from compositions comprising in addition to PTFE, also suitable inorganic and/or organic fillers, such as graphite, carbon fibers and others. Apart from an improvement in the mechanical properties, the addition of filler also leads to an increase in wear resistance of the sealing element produced from the composition. Moreover, the addition of filler also leads to at least a slight improvement in the cold flow properties, in that the cold flow of the composition or of the sealing elements produced therefrom is reduced. However, sealing elements based on filler-containing PTFE compositions still have an excessively high tendency to creep under pressure and to cold flow, and therefore sealing elements of this kind are restricted to applications with low to moderate pressure differentials. For piston rings, guide rings and packing rings, however, better pressure creep and cold flow properties are desirable, which permits the use of the corresponding sealing rings at higher pressure differentials. A further property of PTFE is its comparatively high melt viscosity, the effect of which is that PTFE in the molten state is not liquid but in the form of a gel, and so PTFE cannot be processed thermoplastically, but can only be processed by pressing and sintering techniques and ram extrusion.

To improve the cold flow properties, EP 0 933 566 A1 has already proposed replacing PTFE with a perfluoroalkoxy polymer (PFA). By contrast with PTFE, PFA has side chains, namely alkoxy side chains, which reduce the cold flow tendency compared to PTFE, because the PFA molecules, owing to the side chains, can slide past one another only with greater difficulty than the linear PTFE molecules. PFA has a comparatively low melt viscosity and cannot be sintered in a mold-free manner.

Proceeding therefrom, it is an object of the present invention to provide a sealing element and/or a guide ring from a composition which has improved pressure creep and cold flow properties and hence is usable at higher pressure differentials, but which nevertheless features outstandingly high chemical and thermal stability and can be sintered in a mold-free manner.

This object is achieved in accordance with the invention by a sealing element and/or a guide ring manufactured from a composition comprising:
i) 50% to 98% by weight polytetrafluoroethylene (PTFE) and/or chemically modified polytetrafluoroethylene,
ii) 1% to 49% by weight perfluoroalkoxy polymer (PFA) and
iii) 1% to 49% by weight of an inorganic filler selected from the group comprising charcoal, graphite, glass fibers, carbon fibers, molybdenum disulfide, metals such as copper, alloys such as bronze, ceramic particles such as aluminum oxide and any desired mixtures of two or more of the aforementioned substances.

This solution is based on the surprising finding that addition of comparatively small amounts of PFA to a composition comprising PTFE or chemically modified PTFE and filler can significantly improve the pressure creep and cold flow properties of the composition, and these can thus be used at higher pressure differentials, particularly surprisingly without worsening the other advantageous properties of known compositions based on PTFE or modified PTFE and filler, such as high chemical and thermal stability, and at the same time can ensure processing by mold-free sintering. Apart from that, the improved microporosity of PFA compared to PTFE allows better attachment particularly of inorganic fillers to the polymer component of the composition, which can further improve the performance properties of the composition. Thus, the PFA to some degree functions as an adhesion promoter between the filler and the PTFE. Due to all these properties, the composition is of excellent suitability as material for the sealing elements of the invention, such as piston rings or packing rings and guide rings such as piston guide rings and guiding sealing rings such as piston guide sealing rings. Such sealing elements and/or guide rings are especially used in piston compressors, especially for sealing-off and/or guiding the piston or the piston rod. Such piston compressors are used for compression of gases.

In the context of the present invention, chemically modified polytetrafluoroethylene is understood to mean a polymer composed of tetrafluoroethylene monomer and less than 1% by weight of comonomer and preferably 0.1-0.2% by weight of comonomer, for example perfluoroalkoxyvinylether. Since the comonomer content is below 1% by weight, modified PTFE can be classified as a homopolymer in accordance with DIN EN ISO 12086. By contrast, perfluoroalkoxy polymer is understood to mean a copolymer of tetrafluoroethylene and perfluoroalkoxy comonomer containing more than 1% by weight of perfluoroalkoxy comonomer and preferably 1.5% to 5% by weight and more preferably 1.5% to 2% by weight of perfluoroalkoxy comonomer.

In order to achieve the advantageous properties achievable by the present invention to a particularly high degree, what is proposed in a development of the concept of the invention is that the composition of the sealing element and/or guide ring consists to an extent of 50% to 100% by weight of constituents i), ii) and iii). If the sum total of constituents i), ii) and iii) is less than 100% by weight, the composition comprises, as remainder to 100% by weight, one or more further polymers preferably selected from the group consisting of polyphenylene sulfides (PPS), polyphenylene sulfones (PPSO₂), polyetheretherketones (PEEK), polyimides and any desired mixtures of two or more of the aforementioned polymers. Particularly good results are obtained particularly with regard to processibility and pressure creep and cold flow properties when the composition consists to an extent of 65% to 100% by weight, more preferably to an extent of 75% to 100% by weight, even more preferably to an extent of 85% to 100% by weight and most preferably entirely of constituents i), ii) and iii), where the remainder to 100% by weight, if the sum total of constituents i), ii) and iii) is less than 100% by weight, is one or more polymers preferably selected from the group consisting of polyphenylene sulfides (PPS), polyphenylene sulfones (PPSO₂), polyetheretherketones (PEEK), polyimides and any desired mixtures of two or more of the aforementioned substances.

In a particularly preferred embodiment of the present invention, the composition of the sealing element and/or guide ring consists of:
i) 50% to 93% by weight polytetrafluoroethylene and/or chemically modified polytetrafluoroethylene,
ii) 5% to 30% by weight and more preferably 5% to 25% by weight perfluoroalkoxy polymer and
iii) 2% to 49% by weight of an inorganic filler selected from the group comprising charcoal, graphite, glass fibers, carbon fibers, molybdenum disulfide, metals such as copper, alloys such as bronze, ceramic particles such as aluminum oxide and any desired mixtures of two or more of the aforementioned substances.

Therefore, in this embodiment, the sum total of constituents i), ii) and iii) is 100% by weight. Such a composition does not just have particularly good processibility, especially by mold-free sintering, but especially also features excellent pressure creep and cold flow properties and, to a good extent, the further properties that are important for sealing elements.

With regard to the aforementioned advantages and properties, it is even more preferable that the composition of the sealing element and/or guide ring consists of:
i) 50% to 93% by weight polytetrafluoroethylene and/or chemically modified polytetrafluoroethylene,
ii) 5% to 15% by weight perfluoroalkoxy polymer and
iii) 2% to 30% by weight of an inorganic filler selected from the group comprising charcoal, graphite, glass fibers, carbon fibers, molybdenum disulfide, metals such as copper, alloys such as bronze, ceramic particles such as aluminum oxide and any desired mixtures of two or more of the aforementioned substances.

In principle, the present invention is not particularly restricted with regard to the type of PTFE i) used. Particularly with regard to chemical and thermal stability and integrity, it is preferable, however, that the composition comprises, as constituent i), high molecular weight polytetrafluoroethylene and/or chemically modified polytetrafluoroethylene having a number-average molecular weight Mn of greater than 10⁶ g/mol and a first melting temperature (Tm) of 335° C. or higher.

Preferably, the PTFE is granular PTFE that has been obtained by suspension polymerization.

In addition, it has been found to be advantageous to use PTFE and/or chemically modified PTFE having an average particle size measured according to DIN ISO 13320 of 20 to 650 μm and more preferably of 20 to 50 μm.

As constituent ii), preference is given to using a perfluoroalkoxy polymer (PFA) having the following general formula:

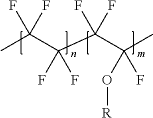

in which R is a C₁₋₄-perfluoroalkyl radical and preferably a C₁₋₃-perfluoroalkyl radical and m and n give the number of repeat units. Preferably, n and m are independently a number from 1 to 10000. PFAs of this kind lead not only to a particularly marked improvement in the pressure creep and cold flow properties of the articles produced from the composition, such as sealing elements in particular, but also to high chemical and thermal stability, and to good processibility by mold-free sintering.

Preferably, the perfluoroalkoxy polymer ii) has a melt flow index determined according to DIN EN ISO 1133 with 5 kg at 372° of 1 to 30 g/10 min and preferably a melt flow index of 2 to 20 g/10 min.

In addition, it has been found to be advantageous to use PFA having an average particle size measured according to DIN ISO 13320 of 20 to 650 μm and more preferably of 20 to 50 μm.

The present invention further provides a sealing element and/or guide ring manufactured from a composition comprising:
i) 50% to 98% by weight polytetrafluoroethylene and/or chemically modified PTFE,
ii) 1% to 49% by weight of a thermoplastic perfluoropolymer other than polytetrafluoroethylene and
iii) 1 to 49% by weight of an inorganic filler selected from the group comprising charcoal, graphite, glass fibers, carbon fibers, molybdenum disulfide, metals such as copper, alloys such as bronze, ceramic particles such as aluminum oxide and any desired mixtures of two or more of the aforementioned substances.

In this aspect of the present invention too, it is preferable that the composition of the sealing element and/or guide ring consists to an extent of 50% to 100% by weight, preferably to an extent of 65% to 100% by weight, more preferably to an extent of 75% to 100% by weight, even more preferably to an extent of 85% to 100% by weight and most preferably entirely of constituents i), ii) and iii), where the remainder to 100% by weight, if the sum total of constituents i), ii) and iii) is less than 100% by weight, is one or more polymers preferably selected from the group consisting of polyphenylene sulfides (PPS), polyphenylene sulfones (PPSO₂), polyetheretherketones (PEEK), polyimides and any desired mixtures of two or more of the aforementioned substances.

In this aspect of the present invention, the composition of the sealing element and/or guide ring preferably consists of:
i) 50% to 93% by weight polytetrafluoroethylene and/or chemically modified PTFE,
ii) 5% to 30% by weight of a thermoplastic perfluoropolymer other than polytetrafluoroethylene and
iii) 2% to 49% by weight of an inorganic filler selected from the group comprising charcoal, graphite, glass fibers, carbon fibers, molybdenum disulfide, metals such as copper, alloys such as bronze, ceramic particles such as aluminum oxide and any desired mixtures of two or more of the aforementioned substances.

Particularly good results are obtained when the composition of the sealing element and/or guide ring consists of:
i) 55% to 93% by weight polytetrafluoroethylene and/or chemically modified PTFE,
ii) 5 to 15% by weight of a thermoplastic perfluoropolymer other than polytetrafluoroethylene and
iii) 2 to 30% by weight of an inorganic filler selected from the group comprising charcoal, graphite, glass fibers, carbon fibers, molybdenum disulfide, metals such as copper, alloys such as bronze, ceramic particles such as aluminum oxide and any desired mixtures of two or more of the aforementioned substances.

Due to the advantageous properties of the composition, the sealing element of the invention is preferably a piston ring or a packing ring and a guide ring.

The present invention further provides a process for producing an above-described sealing element and/or guide ring, comprising the following steps:
a) providing an above-described composition,
b) forming and sintering the composition provided in step a) to give a raw blank,
c) mechanically processing the raw blank provided in step b) to give the sealing element.

The forming and sintering in step b) can be conducted in two different process steps conducted in succession or simultaneously.

Preferably, the forming and sintering in step b) is carried out i) by pressing the composition to form a green body and then sintering to form a raw blank, ii) by pressure sintering or iii) by RAM-extrusion.

Finally, the present invention relates to a piston compressor comprising at least one above-described sealing element and/or one above-described guide ring.

The present invention is described hereinafter with reference to a working example that elucidates but does not restrict the present invention.

### EXAMPLE 1

The following composition was produced by mixing:

70% by weight of DuPont™ Teflon® PTFE 7A X,
5% by weight of PFA having a melt flow index of 10-17 g/10 min,
21% by weight of carbon powder having a particle size distribution of D₉₀=40 μm and a BET surface area of 10 m²/g and
4% by weight of graphite having a particle size distribution of D₉₀=56 μm and a BET surface area of 7 m²/g.

This composition was processed by mold-free sintering to give a hollow cylinder, by first compressing the composition at room temperature to give a hollow cylinder as green body having an inner diameter of 40 mm, having an outer diameter of 80 mm and having a height of 175 mm, before the green body thus obtained was sintered in an oven at a temperature of 375° C. to give a raw blank.

Subsequently, this raw blank was processed mechanically by material-removing processing to provide packing rings having an inner diameter of 50 mm, having an outer diameter of 74 mm and having a height of 4 mm.

The packing rings thus produced featured excellent pressure creep and cold flow properties.

### EXAMPLE 2

Analogously to example 1, four different hollow cylinders were produced from a composition that comprised 0% by weight, 5% by weight, 10% by weight and 15% by weight of PFA, 21% by weight of carbon powder, 4% by weight of graphite and PTFE as the remainder to 100% by weight.

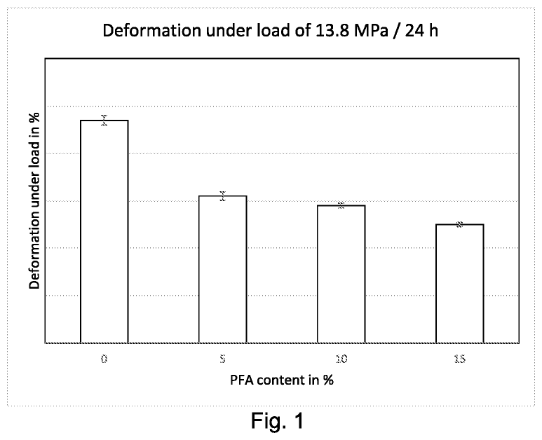

The deformation of these 4 shaped bodies was measured under a load of 13.8 MPa within 24 hours. The results are shown in FIG. 1 and show that even the addition of 5% by weight of PFA leads to a significant reduction in deformation under load, and an increase in the PFA content has a smaller effect thereon.

1. A sealing element and/or guide ring manufactured from a composition comprising:
i) 50% to 98% by weight of polytetrafluoroethylene and/or modified polytetrafluoroethylene,
ii) 1% to 49% by weight of perfluoroalkoxy polymer and
iii) 1% to 49% by weight of an inorganic filler selected from the group consisting of charcoal, graphite, glass fibers, carbon fibers, molybdenum disulfide, metals, alloys, ceramic particles and any mixtures of two or more of the aforementioned substances,
wherein the chemically modified polytetrafluoroethylene optionally present is a polymer composed of tetrafluoroethylene monomer and less than 1% by weight of comonomer, and
wherein the perfluoroalkoxy polymer is a copolymer of tetrafluoroethylene and perfluoroalkoxy comonomer containing more than 1% by weight of perfluoroalkoxy comonomer.

2. The sealing element and/or guide ring as claimed in claim 1,
characterized in that
the composition consists to an extent of 50% to 100% by weight, preferably to an extent of 65% to 100% by weight, more preferably to an extent of 75% to 100% by weight, even more preferably to an extent of 85% to 100% by weight and most preferably entirely of constituents i), ii) and iii), where the remainder to 100% by weight, if the sum total of constituents i), ii) and iii) is less than 100% by weight, is one or more polymers preferably selected from the group consisting of polyphenylene sulfides, polyphenylene sulfones, polyetheretherketones, polyimides and any desired mixtures of two or more of the aforementioned substances.

3. The sealing element and/or guide ring as claimed in claim 1 or 2,
characterized in that
the composition consists of:
i) 50% to 93% by weight of polytetrafluoroethylene and/or chemically modified polytetrafluoroethylene,
ii) 5% to 25% by weight of perfluoroalkoxy polymer and
iii) 2% to 49% by weight of an inorganic filler selected from the group consisting of charcoal, graphite, glass fibers, carbon fibers, molybdenum disulfide, metals such as copper, alloys such as bronze, ceramic particles such as aluminum oxide and any desired mixtures of two or more of the aforementioned substances.

4. The sealing element and/or guide ring as claimed in claim 3,
characterized in that
the composition consists of:
i) 55% to 93% by weight of polytetrafluoroethylene and/or chemically modified polytetrafluoroethylene,
ii) 5% to 15% by weight of perfluoroalkoxy polymer and
iii) 2% to 30% by weight of an inorganic filler selected from the group consisting of charcoal, graphite, glass fibers, carbon fibers, molybdenum disulfide, metals such as copper, alloys such as bronze, ceramic particles such as aluminum oxide and any desired mixtures of two or more of the aforementioned substances.

5. The sealing element and/or guide ring as claimed in at least one of the preceding claims,
characterized in that
the polytetrafluoroethylene and/or chemically modified polytetrafluoroethylene i) has a number-average molecular weight of 10⁶ g/mol or greater.

6. The sealing element and/or guide ring as claimed in at least one of the preceding claims,
characterized in that
the polytetrafluoroethylene and/or chemically modified polytetrafluoroethylene i) has an average particle size measured according to DIN ISO 13320 of 20 to 650 μm and preferably of 20 to 50 μm.

7. The sealing element and/or guide ring as claimed in at least one of the preceding claims,
characterized in that
the perfluoroalkoxy polymer ii) has the following general formula: 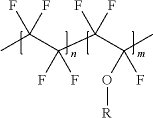
in which R is a C₁₋₄-perfluoroalkyl radical and preferably a C₁₋₃-perfluoroalkyl radical and m and n represent the number of repeating units, where n and m are preferably independently a number from 1 to 10000.

8. The sealing element and/or guide ring as claimed in at least one of the preceding claims,
characterized in that
the perfluoroalkoxy polymer ii) has a melt flow index measured according to DIN EN ISO1133 with 5 kg at 372° of 1 to 30 g/10 min and preferably a melt flow index of 2 to 20 g/10 min.

9. The sealing element and/or guide ring as claimed in at least one of the preceding claims,
characterized in that
the perfluoroalkoxy polymer ii) has an average particle size measured according to DIN ISO 13320 of 20 to 650 μm and preferably of 20 to 50 μm.

10. The sealing element and/or guide ring, wherein the composition comprises:
i) 50% to 98% by weight of polytetrafluoroethylene and/or modified polytetrafluoroethylene,
ii) 1% to 49% by weight of a thermoplastic perfluoropolymer other than polytetrafluoroethylene and
iii) 1% to 49% by weight of an inorganic filler selected from the group consisting of charcoal, graphite, glass fibers, carbon fibers, molybdenum disulfide, metals such as copper, alloys such as bronze, ceramic particles such as aluminum oxide and any desired mixtures of two or more of the aforementioned substances.

11. The sealing element and/or guide ring as claimed in at least one of the preceding claims,
characterized in that
it is a piston ring or a packing ring.

12. A process for producing a sealing element and/or guide ring as claimed in at least one of the preceding claims, comprising the steps of:
a) providing a composition having the features relating to the composition as claimed in at least one of claims 1 to 10,
b) forming and sintering the composition provided in step a) into a raw blank,
c) mechanically processing the raw blank provided in step b) into the sealing element.

13. The process as claimed in claim 12,
characterized in that
the forming and sintering in step b) is carried out i) by pressing the composition to form a green body and then sintering to form a raw blank, ii) by pressure sintering or iii) by extrusion into a green body and subsequent sintering into a raw blank.

14. A piston compressor comprising at least one sealing element and/or guide ring as claimed in at least one of claims 1 to 11.
